(19) United States
(12) Patent Application Publication
(10) Pub. No.: US 2015/0205775 A1
(43) Pub. Date: Jul. 23, 2015

(54) Managing Documents and Document Workspaces

(71) Applicants: Eric Berdahl, San Jose, CA (US); Marissa Dulaney, Morgan Hill, CA (US); Jesper Storm Bache, Menlo Park, CA (US)

(72) Inventors: Eric Berdahl, San Jose, CA (US); Marissa Dulaney, Morgan Hill, CA (US); Jesper Storm Bache, Menlo Park, CA (US)

(21) Appl. No.: 12/257,097

(22) Filed: Oct. 23, 2008

Related U.S. Application Data
(60) Provisional application No. 61/049,729, filed on May 1, 2008.

(51) Int. Cl. G06F 3/048; G06F 3/0484; G06F 17/21

(52) U.S. Cl. CPC G06F 17/24; G06F 17/212; G06F 3/04842; G06F 3/04845

(57) ABSTRACT

A computer-implemented method for combining documents includes displaying one or more documents in a first document group in a source window; displaying one or more documents in a second document group in a target window; receiving an instruction to move the source window towards the target window; moving the source window so that it overlaps the target window; receiving an instruction to release the source window; and combining the documents in the first document group with the documents in the second document group to create a new document group in the target window, where the new document group comprises a first document subgroup which comprises the documents in the first document group and a second document subgroup which comprises the documents in the second document group, and where the target window is subdivided with a visual indication that the first document subgroup is separate from the second document subgroup.

### CROSS-REFERENCE TO RELATED APPLICATIONS

This application claims priority to pending U.S. Provisional Application Ser. No. 61/049,729, filed May 1, 2008, the entire contents of which are hereby incorporated by reference.

### BACKGROUND

The present disclosure relates to managing documents, document workspaces, and application controls.

Applications for viewing and editing documents can have complex user interfaces. Typical user interfaces include windows that display documents, windows that display controls (e.g., panels), and windows that display documents and controls. The controls can provide access to operations that can be performed on documents. Various user interfaces have a single window that can operate as a document workspace and display multiple documents and controls.

Users spend time and energy organizing a workspace, including arranging windows, documents, and controls in a way that provides an efficient workflow. Applications that provide workspace management allow users to concentrate more on document content rather than managing windows.

### SUMMARY

In general, one or more aspects of the subject matter described in this specification can be embodied in one or more methods that include displaying one or more documents in a first document group in a source window. One or more documents are displayed in a second document group in a target window. An instruction is received to move the source window towards the target window. The source window is moved so that it overlaps the target window. An instruction is received to release the source window. The documents in the first document group are combined with the documents in the second document group to create a new document group. Other embodiments of this aspect include corresponding systems, apparatus, and computer program products.

These and other embodiments can optionally include one or more of the following features. One or more documents in the new document group are displayed in the target window. A visual affordance associated with the new document group is displayed, where the visual affordance is operable to select one of the documents in the new document group. The visual affordance can include a plurality of tabs where each tab displays a name of one of the documents in the new document group. Combining the documents in the first document group with the documents in the second document group can include: creating a new document group that comprises the documents in the first document group and the documents in the second document group; or creating a new document group with a first document subgroup and a second document subgroup, where the first document subgroup comprises the documents in the first document group and the second document subgroup comprises the documents in the second document group. Receiving an instruction to move the source window towards the target window can include receiving an instruction to drag a title bar associated with the source window towards the target window. Receiving an instruction to release the source window can include displaying a visual indicator that the documents in the first and second document groups will be combined when the source window is released.

In general, one or more aspects of the subject matter described in this specification can be embodied in one or more methods that include receiving input selecting a first document in a first window. Input is received to a first control displayed in a second window, where one or more overlapping windows overlap the second window. Without bringing the second window forward, an operation associated with the first document is performed, where the operation is based on the input to the first control. Other embodiments of this aspect include corresponding systems, apparatus, and computer program products.

These and other embodiments can optionally include one or more of the following features. The first control can comprise one of the following: a menu comprising a list of operations, a push-button, a sliding tool, a selectable color map, a list box, a checkbox, a toggle button, an edit field for typing, or a thumbnail image including a selectable image region. The operation can comprise one of the following: performing image processing on the first document, displaying a selected portion of the first document, saving the first document, changing properties on the document or on an object in the document, running an automated action on the document, or applying a color to a selected region of the first document. Receiving input selecting a first document in a first window can include bringing the first window forward. Input is received selecting a second document in the second window. The second window is brought forward.

Particular embodiments of the invention can be implemented to realize one or more of the following advantages. Combining document groups is more intuitive to users than previous methods of combining document groups, such as closing and re-opening documents. Users can quickly combine document groups. Users can perform operations on documents using controls in windows that are partially hidden without bringing those windows forward. Consequently, users spend less time managing their document workspaces. Users are encouraged and enabled to use workflows that require multiple documents to be viewed at once or used together, e.g., compositing or comparing images.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIGS. 1A-1E illustrate an example of combining document groups in windows.

FIG. 2 illustrates a flowchart of an example technique for combining document groups.

FIGS. 3A-3D illustrate an example of partially activating a window.

FIG. 4 illustrates a flowchart of an example technique for partially activating a window.

FIG. 5 is a schematic diagram of a generic computer system.

Like reference numbers and designations in the various drawings indicate like elements.

### DETAILED DESCRIPTION

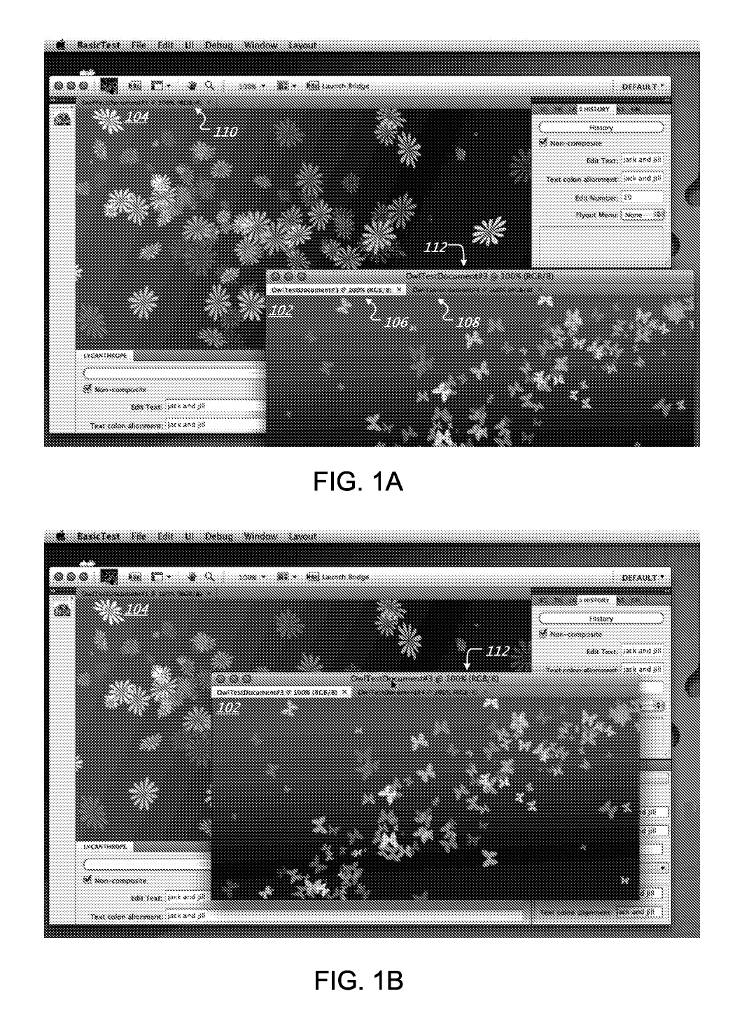

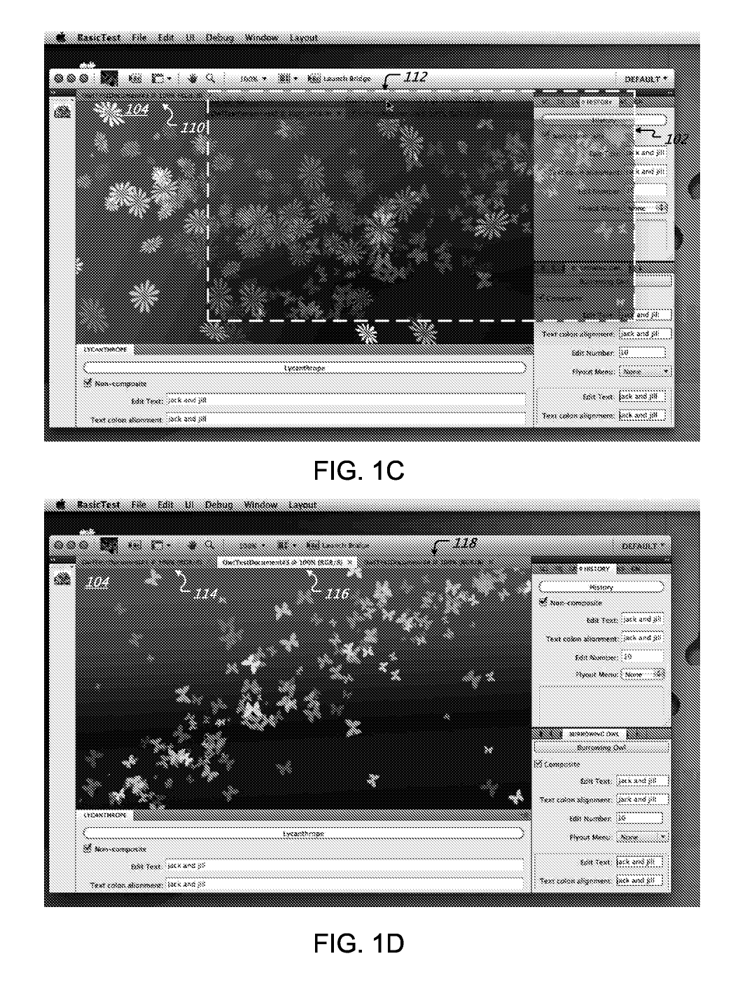

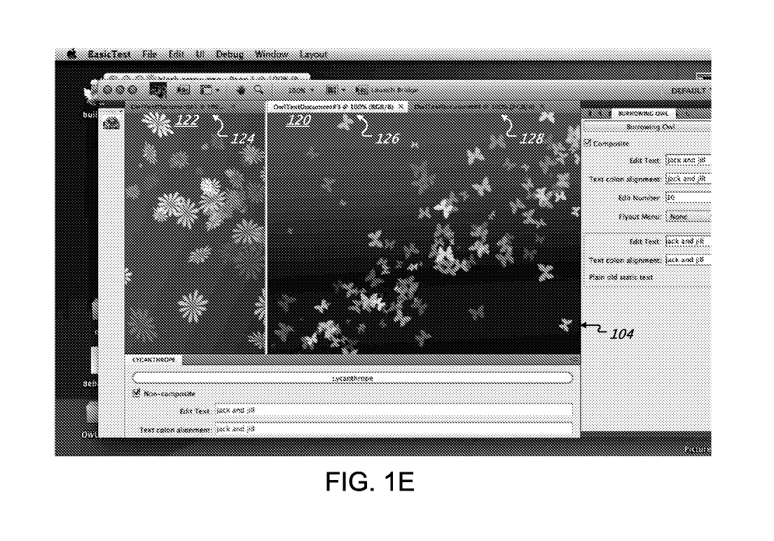

FIGS. 1A-1E illustrate an example of combining document groups in windows which involves interactively moving a group of one or more documents in one window and combining them with one or more documents in another window.

FIG. 1A illustrates a source window 102 and a target window 104. The source window 102 is associated with a first document group having two documents, “OwlTestDocument#3” and “OwlTestDocument#4.” The source window 102 displays “OwlTestDocument#3.” The target window 104 is associated with a second group of documents having only one document, “OwlTestDocument#1.” The target window 104 displays that document.

The source window 102 and the target window 104 have tabs 106, 108, and 110. The tabs display the names of documents in the document groups. A user can select (e.g., click with a mouse) a tab to display the document whose name is displayed on the tab. The source window 102 has a title bar 112, and the tabs 110 of the target window 104 act as a title bar for the target window 104. A title bar can display the name of the document that is displayed in its corresponding window or other information.

FIG. 1B illustrates selection of the source window 102. The source window 102 is the window from which one or more documents in a document group will be transferred. A user positions the cursor over the source window title bar 112 and clicks the title bar to select the source window. FIG. 1B also illustrates dragging the source window 102 towards the target window 104. The user drags the window by selecting the title bar 112 and dragging the title bar.

FIG. 1C illustrates a user dragging the source window 102 to a point where the title bar 112 of the source window 102 overlaps the tabs 110 of the target window 104. The source window 102 appears transparent. This provides a visual indicator to a user that if the source window 102 is released, the documents in the first and second document groups will be combined.

FIG. 1D illustrates a result of combining the documents in the first and second document groups. In this example, the source window is no longer displayed. The target window 104 is associated with a new document group that contains the documents in the first and second document groups. The target window has tabs 114, 116, and 118 showing the names of the documents in the new document group.

FIG. 1E illustrates an alternative result of combining the documents. In FIG. 1E, a new document group has two document subgroups, including one document subgroup containing the documents in the first document group and one document subgroup containing the documents in the second document group.

The target window 104 is associated with the new document group. The target window displays each of the subgroups within the new document group. The target window is subdivided, and one subdivision 120 displays one of the documents in the first document group and another subdivision 122 displays one of the documents in the second document group. Each subdivision has tabs 124, 126 and 128 that provide access to documents that are not currently displayed.

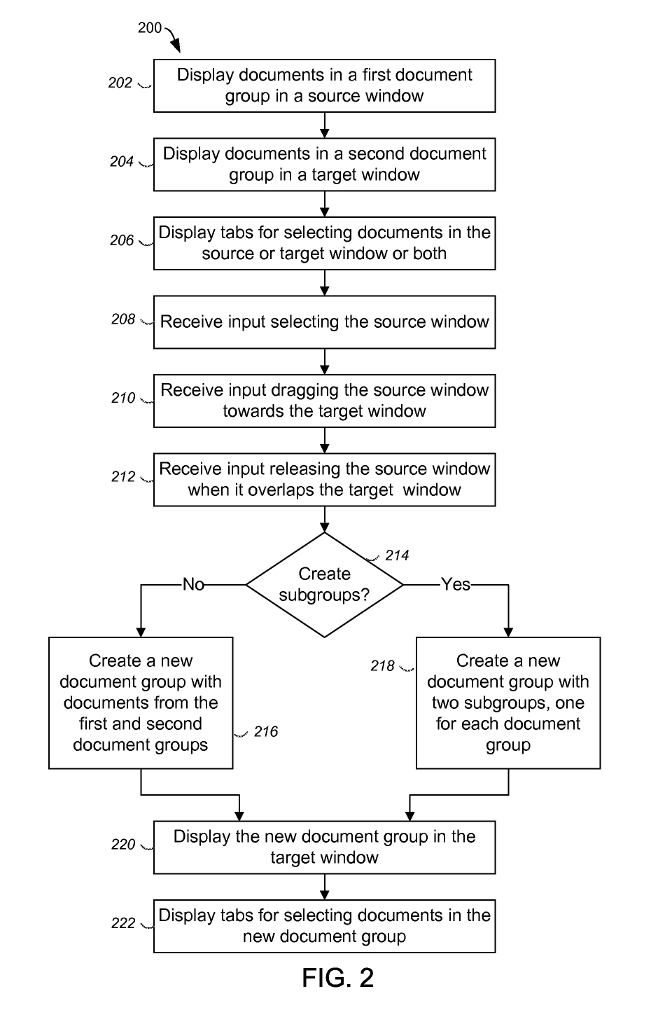

FIG. 2 illustrates a flowchart of an example technique 200 for combining document groups. For purposes of illustration, the technique will be described with respect to a system (e.g., generic computer system 500, a mobile device such as a smart phone or a digital camera, one or more servers such as a web server, or the like) that performs the technique.

The system displays one or more documents in a first document group in a source window (step 202). The system displays one or more documents in a second document group in a target window (step 204). A window is a visual shape in a graphical user interface, typically rectangular, containing some kind of user interface. For example, FIG. 1A shows two windows 102 and 104. Windows can be in various formats and can typically be moved and resized.

A document does not necessarily correspond to a file. A document can be stored in a portion of a file that holds other documents, in a single file dedicated to the document in question, or in multiple coordinated files. A document can also be stored in memory. Each of the documents can be of a different type. Alternatively, the documents can all be the same type. The documents can be images, movies, audio clips, word processing documents, spreadsheets, web pages, emails, combinations including documents embedded within documents, and the like. A document can also be a view on a composition or a subset of a larger composition.

A document group is one or more documents that are related. For example, in some cases, the documents are related because a user is working with all of them. Alternatively, the system can select certain documents and determine that they are related. For example, the system can determine that documents with the same file format are related, or that documents with the same file name extension are related.

In some implementations, the system displays a visual affordance for selecting documents in one or both of the target and source windows (step 206). A visual affordance is associated with a document group. A visual affordance is operable to select one of the documents in its associated document group. For example, the system can display a visual affordance in the source window if the document group being displayed in the source window has more than one document. The visual affordance can be, for example, a plurality of tabs where each tab displays a name (e.g., a text label by which the program identifies a document to a user) of one of the documents in an associated document group (for example, tabs 106, 108, and 110 in FIG. 1A), or a menu for selecting documents, or the like. Other visual affordances are possible.

The system receives an instruction to move the source window towards the target window (step 208). The system moves the source window so that it overlaps the target window (step 210). For example, in FIG. 1B, the source window 102 is moving towards the target window 104—it is closer to the target window 104 than it was in FIG. 1A. In some implementations, the system receives mouse input moving the source window. In other implementations, the system receives trackball input, keyboard input (e.g., from the arrow keys), or other input moving the source window. In various implementations, receiving an instruction to move the source window towards the target window comprises receiving input dragging a title bar associated with the source window towards the target window.

The system receives an instruction to release the source window (step 212). An instruction to release the source window can be, for example, releasing a mouse button, pressing the “escape” key, double clicking a mouse button, and so on. The instruction to release the source window indicates that the source window has moved to a desired position.

The system combines the documents in the first document group with the documents in the second document group. For example, the system can add the documents in the first document group to the second document group, thus creating a new document group. In various implementations, the system prompts a user for confirmation that combining document groups is desired. For example, the system can display a dialog box allowing the user to cancel the combination.

In some implementations, the system combines the documents whenever the source window is released and it overlaps the target window. In other implementations, the system only combines the documents if the source window overlaps the target window in a particular way. For example, in various implementations, the system only combines the documents when a particular part of the source window (e.g., a title bar or a plurality of tabs, or the like) overlaps a particular part of the target window (e.g., a title bar or a plurality of tabs, or the like).

In some implementations, when the source window overlaps the target window (or when the source window overlaps the target window in a particular way), the system displays a visual indicator that the documents will be combined if the source window is released. For example, the system can display the source window as partially transparent (e.g., as illustrated in FIG. 1C), or the system can flash the source window or the target window, or the system can display a thick border or frame around the source window of the target window, and so on. Other visual indicators are possible.

In some implementations, the system determines whether to create subgroups (step 214). If the system decides to create subgroups, the system creates a new document group with a first document subgroup and a second document subgroup (step 218). The first document subgroup comprises the documents in the first document group and the second document subgroup comprises the documents in the second document group. If the system decides not to create subgroups, the system creates a new document group that comprises the document in first document group and the documents in the second document group (step 216).

The system can determine whether to create subgroups by receiving user preferences. In some implementations, the system receives fixed preferences from a user, for example, through a “settings” or “options” menu. In other implementations, the system receives user preferences dynamically. For example, a user can click a “control” or “alt” key when releasing the source window to instruct the system to create subgroups.

In some implementations, the system displays one or more documents in the new document group in the target window (step 220). Typically, the displayed documents can be edited, viewed, or otherwise manipulated by an application that controls the target window. For example, if one of the displayed documents is a spreadsheet, a user can insert new values into the spreadsheet. If the system created subgroups, the system can subdivide the target window and display one or more documents from each subgroup in each subdivision of the target window. For example, FIG. 1E shows a target window 104 divided into two subdivisions 122 and 120.

In some implementations, the system displays a visual affordance (e.g., a plurality of tabs) associated with the new document group (step 222). The system can decide whether to display a visual affordance based on, for example, user preferences or the number of documents in the new document group. The visual affordance is operable to select one of the documents in the new document group.

In some implementations, after combining the document groups, the system no longer displays the source window. The system moves the documents from the source window into the target window and closes the source window. In other implementations, the system copies the document from the source window into the target window. The system continues to display the source window. In various implementations, the system decides whether to copy or move the documents based on user input. For example, the system can copy the documents when the user holds a key (e.g., the “control” key or the “alt” key) while releasing the source window, and the system can move the documents if the user does not hold the key.

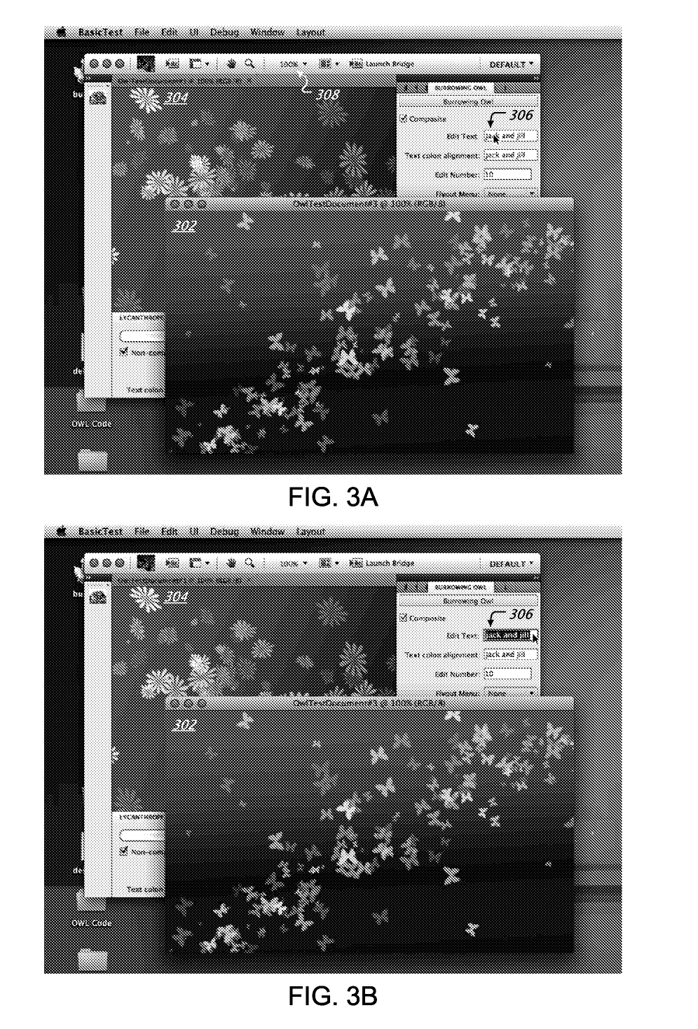

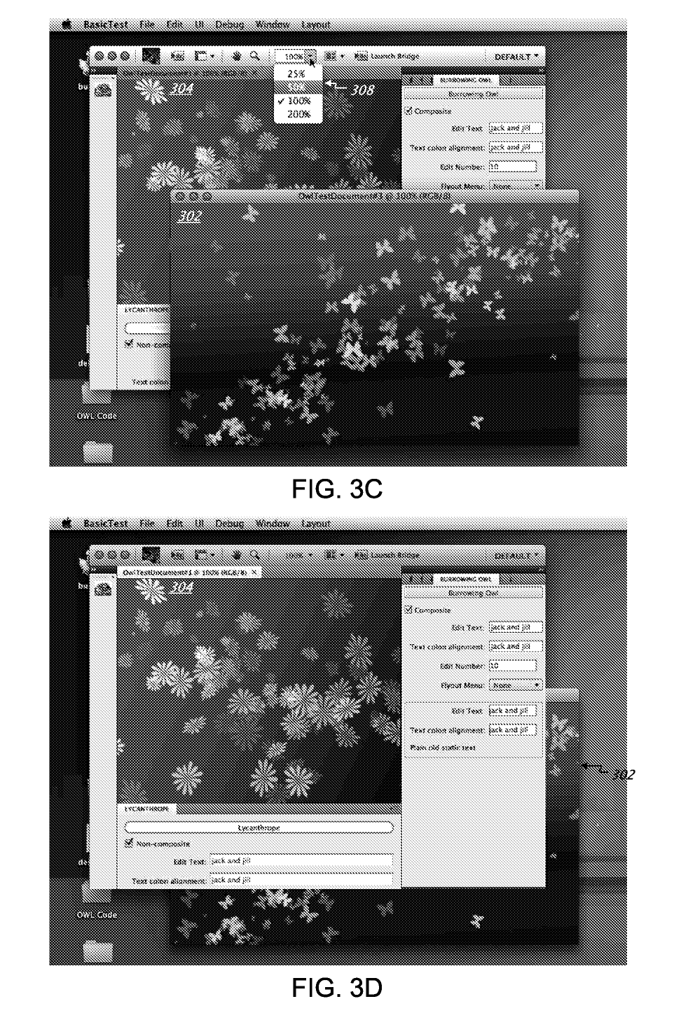

FIGS. 3A-3D illustrate an example of partially activating a window. In a typical graphical user interface with windows, when a user selects a window or something (e.g., a document or a control) in the window, that window is automatically brought forward (i.e., in front of one or more other windows or all other windows). Bringing the window forward allows the user to work with that window and all of its contents. However, when a user has many windows open, the user may wish to select a control in a window without bringing it forward, for example, because bringing that window forward would obstruct another window that the user is working with.

FIG. 3A illustrates a first window 302 displaying a first document and a second window 304 having controls, e.g., 306 and 308. The first window 302 overlaps the second window 304, i.e., the first window is in front of the second window.

FIG. 3B illustrates editing text in a text box control 306. The second window 304 displays the text box control. A user is using the text box control to specify an operation to perform that is associated with the document displayed in the first window 302. For example, the text box control can change metadata associated with the document in the first window. Although a user is using a control in the second window 304, the second window 304 is not brought in front of the first window 302. Thus, the second window is partially activated.

Similarly, FIG. 3C illustrates specifying a zoom level from a drop down menu control 108 in the second window 104. The drop down menu can change the zoom level (i.e., how large or small a document is displayed) of the document in the first window 102 even though the menu is located in the second window 104. The second window 104 is not brought in front of the first window 102. Again, the second window is partially activated.

FIG. 3D illustrates selection of a document (instead of a control) displayed in the second window 104. The second window 104 is brought in front of the first window 102.

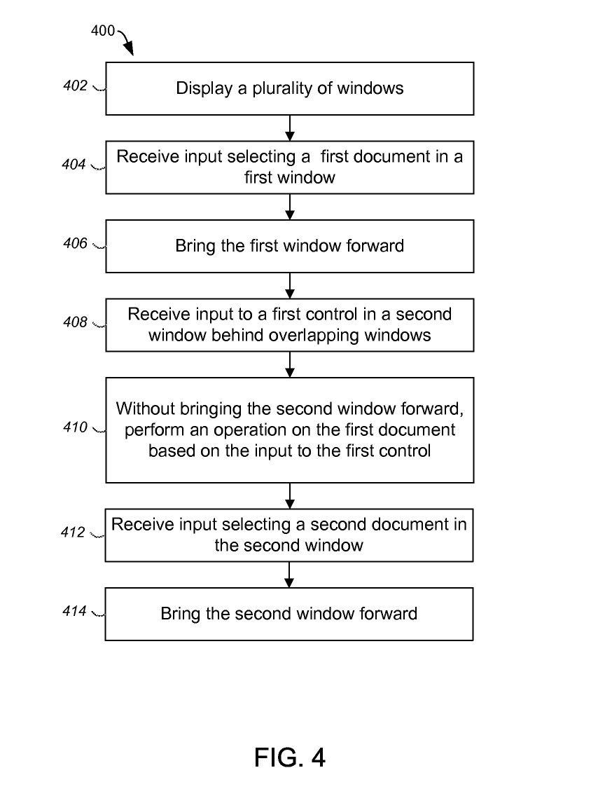

FIG. 4 illustrates a flowchart of an example technique 400 for partially activating a window. For purposes of illustration, the technique will be described with respect to a system (e.g., generic computer system 500, a mobile device such as a smart phone or a digital camera, one or more servers such as a web server, or the like) that performs the technique.

The system displays a plurality of windows (step 402). One or more of the windows are displayed in front of one or more other windows.

The system receives input selecting a first document in a first window (step 404). In some implementations, the system brings the first window forward (step 406). Bringing a window forward comprises displaying the window in front of one or more other displayed document windows, or in some cases, in front of any other displayed document window. In various implementations, the system changes the display of the window to indicate that it has been selected.

The system receives input to a first control in a second window (step 408). One or more overlapping windows overlap the second window. For example, the first window can be one of the overlapping windows. FIGS. 3B and 3C illustrate an example of receiving input to a control.

In some implementations, the first window and the second window are both controlled by the same application. In other implementations, the first window is controlled by one application and the second window is controlled by another. For example, the first window can be a window controlled by an operating system, and the second window can be a window controlled by an image processing application.

A control allows a user to specify operations for an application to perform. For example, a control can be a menu comprising a list of operations, a push-button, a sliding tool, a selectable color map, a list box, a checkbox or toggle button, an edit field for typing, a thumbnail image including a selectable image region, and so on. The input can be, for example, a mouse click to a button control, a menu selection from a menu, a color selection in a color map, a selection of an image region in an image thumbnail, and so on.

Without bringing the second window forward (e.g., in front of one or any of the overlapping windows), the system performs an operation associated with the selected document (step 410). In some implementations, the system brings the second window in front of one or more of the overlapping windows, but not all of them. For example, where the first window overlaps the second window, the system can bring the second window in front of all overlapping windows except the first window.

The operation is based on the input to the first control. The operation can be, for example, performing image processing on the first document, displaying a selected portion (e.g., from a thumbnail image) of the first document, saving the selected document, applying a color to a selected region of the first document, changing properties on the document or on an object in the document, running an automated action on the document, and so on.

In some implementations, the system determines whether to bring the second window forward by receiving input. For example, the system can partially activate the second window if a user holds the “control” or “alt” key while selecting the first control, but bring the second window forward if the user does not hold the appropriate key. In various implementations, the system decides whether or not to bring the second window forward based on what area of the second window (e.g., a document area or a control area) is selected.

In some implementations, the system receives input selecting a second document in the second window (step 412). The system brings the second window forward (step 414). For example, FIG. 3D illustrates an example of a window 304 that was brought forward from its position in FIG. 3C. The system brings the second window forward instead of partially activating it because the user selected a document rather than a control.

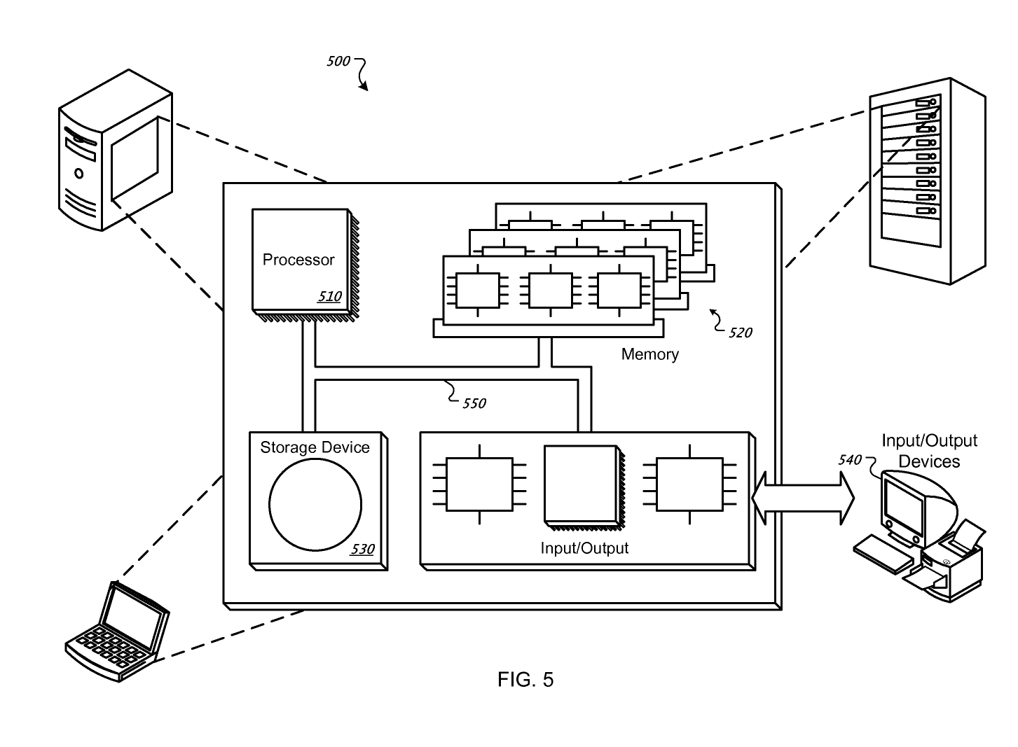

FIG. 5 is a schematic diagram of a generic computer system 500. The system 500 can be used for practicing operations described in association with the techniques shown in FIG. 2 and FIG. 4. The system 500 can include a processor 510, a memory 520, a storage device 530, and input/output devices 540. Each of the components 510, 520, 530, and 540 are interconnected using a system bus 550. The processor 510 is capable of processing instructions for execution within the system 500. In some implementations, the processor 510 is a single-threaded processor. In other implementations, the processor 510 is a multi-threaded processor. The processor 510 is capable of processing instructions stored in the memory 520 or on the storage device 530 to display graphical information for a user interface on the input/output device 540.

The memory 520 is a computer readable medium such as volatile or non volatile memory that stores information within the system 500. The storage device 530 is capable of providing persistent storage for the system 500. The storage device 530 can be a floppy disk device, a hard disk device, an optical disk device, or a tape device, or other suitable persistent storage means. The input/output device 540 provides input/output operations for the system 500. In some implementations, the input/output device 540 includes a keyboard and a pointing device. In other implementations, the input/output device 540 includes a display unit for displaying graphical user interfaces.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

While this specification contains many implementation details, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. For example, the actions recited in the claims can be performed in a different order and still achieve desirable results.

1. A computer-implemented method comprising:
displaying documents in a first document group in a source window;
displaying one or more documents in a second document group in a target window;
receiving an instruction to move the source window towards the target window;
moving the source window so that it overlaps the target window;
receiving an instruction to release the source window; and
combining the documents in the first document group with the one or more documents in the second document group to create a new document group in the target window, where:
the new document group comprises a first document subgroup and a second document subgroup;
the first document subgroup comprises the documents of the first document group and the target window displays visual representations of the documents in the first document group;
the second document subgroup comprises the one or more documents of the second document group and the target window displays a visual representation of the one or more documents in the second document group concurrently with displaying the visual representations of the documents in the first document group; and
the target window is subdivided with a visual divider between the first document subgroup and the second document subgroup, the visual divider having the visual representations of the documents in the first document group displayed on one side thereof and having the visual representation of the one or more documents in the second document group displayed on another side thereof.

2. The method of claim 1, wherein each of the visual representations of the documents in the first document group is operable to select one of the documents in the first document group and the visual representation of the one or more documents in the second document group is operable to select the one or more documents in the second document group.

3. The method of claim 2 where each of the visual representations of the documents in the first document group displays a name of one of the documents in the first document group and the visual representation of the one or more documents in the second document group displays a name of the one or more documents in the second document group.

4. (canceled)

5. The method of claim 1 where:
receiving an instruction to move the source window towards the target window comprises receiving an instruction to drag a title bar associated with the source window towards the target window; and
receiving an instruction to release the source window comprises displaying a visual indicator that the documents in the first and second document groups will be combined when the source window is released.

6. (canceled)

7. (canceled)

8. (canceled)

9. (canceled)

10. (canceled)

11. A computer program product, encoded on a computer-readable medium, operable to cause data processing apparatus to perform operations comprising:
displaying documents in a first document group in a source window;
displaying one or more documents in a second document group in a target window;
receiving an instruction to move the source window towards the target window;
moving the source window so that it overlaps the target window;
receiving an instruction to release the source window; and
combining the documents in the first document group with the one or more documents in the second document group to create a new document group in the target window, where:
the new document group comprises a first document subgroup and a second document subgroup;
the first document subgroup comprises the documents of the first document group and the target window displays visual representations of the documents in the first document group;
the second document subgroup comprises the one or more documents of the second document group and the target window displays a visual representation of the one or more documents in the second document group concurrently with displaying the visual representations of the documents in the first document group; and
the target window is subdivided with a visual divider between the first document subgroup and the second document subgroup, the visual divider having the visual representations of the documents in the first document group displayed on one side thereof and having the visual representation of the one or more documents in the second document group displayed on another side thereof.

12. The computer program product of claim 11 where
each of the visual representations of the documents in the first document group is operable to select one of the documents in the first document group and the visual representation of the one or more documents in the second document group is operable to select the one or more documents in the second document group.

13. The computer program product of claim 12 where each of the visual representations of the documents in the first document group displays a name of one of the documents in the first document group and the visual representation of the one or more documents in the second document group displays a name of the one or more documents in the second document group.

14. (canceled)

15. The computer program product of claim 11 where:
receiving an instruction to move the source window towards the target window comprises receiving an instruction to drag a title bar associated with the source window towards the target window; and
receiving an instruction to release the source window comprises displaying a visual indicator that the documents in the first and second document groups will be combined when the source window is released.

16. (canceled)

17. (canceled)

18. (canceled)

19. (canceled)

20. (canceled)

21. A system comprising:
a computer-readable medium comprising a program product;
a display device; and
one or more processors operable to interact with the display device and to execute the program product and perform operations comprising:
displaying documents in a first document group in a source window;
displaying one or more documents in a second document group in a target window;
receiving an instruction to move the source window towards the target window;
moving the source window so that it overlaps the target window;
receiving an instruction to release the source window; and
combining the documents in the first document group with the one or more documents in the second document group to create a new document group in the target window, where:
the new document group comprises a first document subgroup and a second document subgroup;
the first document subgroup comprises the documents of the first document group and the target window displays visual representations of the documents in the first document group;
the second document subgroup comprises the one or more documents of the second document group and the target window displays a visual representation of the one or more documents in the second document group concurrently with displaying the visual representations of the documents in the first document group; and
the target window is subdivided with a visual divider between the first document subgroup and the second document subgroup, the visual divider having the visual representations of the documents in the first document group displayed on one side thereof and having the visual representation of the one or more documents in the second document group displayed on another side thereof.

22. The system of claim 21 where
each of the visual representations of the documents in the first document group is operable to select one of the documents in the first document group and the visual representation of the one or more documents in the second document group is operable to select the one or more documents in the second document group.

23. The system of claim 22 where each of the visual representations of the documents in the first document group displays a name of one of the documents in the first document group and the visual representation of the one or more documents in the second document group displays a name of the one or more documents in the second document group.

24. (canceled)

25. The system of claim 21 where:
receiving an instruction to move the source window towards the target window comprises receiving an instruction to drag a title bar associated with the source window towards the target window; and
receiving an instruction to release the source window comprises displaying a visual indicator that the documents in the first and second document groups will be combined when the source window is released.

26. (canceled)

27. (canceled)

28. (canceled)

29. (canceled)

30. (canceled)
